(19) United States
(12) Patent Application Publication
(10) Pub. No.: US 2025/0034376 A1
(43) Pub. Date: Jan. 30, 2025

(54) POLYMER PROCESSING AIDS FOR LLDPE COMPOSITIONS

(71) Applicant: Equistar Chemicals, LP, Houston, TX (US)

(72) Inventors: Melanie Longanecker, Akron, OH (US); Jeffrey J. Strebel, Cincinnati, OH (US); Sameer D. Mehta, Mason, OH (US); Harilaos Mavridis, Lebanon, OH (US); Justin P. Glynn, Cincinnati, OH (US)

(73) Assignee: Equistar Chemicals, LP, Houston, TX (US)

(21) Appl. No.: 18/769,135

(22) Filed: Jul. 10, 2024

Related U.S. Application Data
(60) Provisional application No. 63/526,114, filed on Jul. 11, 2023.

(51) Int. Cl. C08L 23/06; C08J 5/18; C08K 3/32; C08K 3/38; C08K 5/098

(52) U.S. Cl. CPC C08L 23/06; C08J 5/18; C08K 3/32; C08K 3/38; C08K 5/098; C08J 2323/06; C08J 2423/12; C08J 2423/20; C08J 2483/04; C08K 2003/385; C08L 2203/16; C08L 2205/025; C08L 2205/06; C08L 2207/066; C08L 2310/00

(57) ABSTRACT

Provided are linear low density polyethylene (LLDPE) compositions including a LLDPE polymer and from 100 ppm to 10,000 ppm of a polymer processing aid (PPA) that is substantially free of fluorine-containing compounds. The non-fluorine-containing inventive PPAs may be a polyphosphite, a polysiloxane, a polyethylene glycol, a high MFR polypropylene, a high MFR polybutene-1, a metal salt of a fatty acid, a polyamide, or a boron nitride. Also provided are polyolefin masterbatches including from 1 wt. % to 50 wt. % of such inventive PPAs and methods of decreasing melt fracture % in linear low density polyethylene films by blending such inventive PPAs and polyolefin masterbatches into cast films and blown films during extrusion processing.

### PRIOR RELATED APPLICATIONS

This application claims the benefit of priority to U.S. Provisional Application No. 63/526,114, filed on Jul. 11, 2023, which is incorporated herein by reference in its entirety.

### FIELD OF THE INVENTION

The present disclosure relates to linear low density polyethylene (LLDPE) compositions containing polymer processing aids and the methods of making the same. More particularly, the present disclosure relates to linear low density polyethylene (LLDPE) compositions, including blown and cast films, containing polymer processing aids that are substantially free of fluoropolymer compounds and methods of making and using the same.

### BACKGROUND OF THE INVENTION

Linear low density polyethylene (LLDPE) is a substantially linear polymer, with significant numbers of short branches, commonly made by copolymerization of ethylene with higher alpha-olefins such as butene, hexene, or octene. LLDPE differs structurally from conventional low density polyethylene (LDPE) because of the absence of long chain branching. LLDPE polymers are commonly produced and sold as pellets or resin, formed in post-polymerization reactor finishing processes (such as extrusion of polymer product that is in an at least partially molten state, followed by pelletization). Additives are commonly blended into the LLDPE pellets or resin as part of this finishing process, such that the LLDPE pellets or resin comprise the LLDPE polymer itself and one or more additives. One of the more common uses of LLDPE resin is the extrusion into blown films and cast films.

Polymer processing aids (PPAs) are a typical additive used in LLDPE resin products. PPAs help make the resin easier to process in downstream manufacturing processes (such as extrusion, rolling, blowing, casting, and stretching). PPAs also help to eliminate melt fracture (as defined below) in blown and cast films made from the LLDPE resin. This is particularly important for grades of LLDPE resins exhibiting relatively higher viscosity in extrusion processing. Melt fracture can adversely affect LLDPE film properties, distort clarity, and reduce gauge uniformity as well as decrease extrusion process productivity. Hence, melt fracture-prone grades of LLDPE for blown film and cast film processing often include PPAs to help eliminate melt fracture, and improve film quality and productivity.

The most common PPAs are, or include, fluoropolymers (fluorine-containing polymers). However, fluoropolymers continue to come under increased scrutiny from an environmental and health perspective. In particular, perfluoroalkyl and polyfluoroalkyl materials are being phased out and/or regulated out of use in many industries. Hence, there is a need to find alternative PPAs that do not include fluoropolymers and/or fluorine for use in LLDPE compositions, while still maintaining the effectiveness of fluoropolymer-based PPAs in preventing melt fractures during blown film processing, cast film processing and other polymer manufacturing processes.

### SUMMARY OF THE INVENTION

In one form of the present disclosure, provided is a linear low density polyethylene (LLDPE) composition comprising a LLDPE polymer and from 100 ppm to 10,000 ppm of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.

In another form of the present disclosure, provided is a polyolefin masterbatch comprising a polyolefin polymer as a carrier resin and from 1 wt. % to 50 wt. % of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.

In yet another form of the present disclosure, provided is a method of decreasing melt fracture in linear low density polyethylene films comprising: extruding a linear low density polyethylene resin into a blown film or cast film on an extrusion line; and blending into the extrusion line a polymer processing aid (PPA) that is substantially free of fluorine-containing compounds to provide from 100 ppm to 10,000 ppm of the polymer processing aid (PPA) in the blown film or cast film, wherein the polymer processing aid is a polyphosphite, a polysiloxane, a polyethylene glycol, a high MFR polypropylene, a high MFR polybutene-1, a metal salt of a fatty acid, a polyamide, or a boron nitride; and wherein the blown film or cast film is such that at 90 minutes of forming the blown film or cast film, % melt fracture (on basis of area of the film's surface) is less than equal to 35%. The polymer processing aid may be directly blended into the extrusion line or blended into the extrusion line as a masterbatch.

In yet another form of the present disclosure, provided is a method of decreasing melt fracture in linear low density polyethylene films comprising: blending a polymer processing aid (PPA) that is substantially free of fluorine-containing compounds to provide from 100 ppm to 10,000 ppm of the polymer processing aid (PPA) into a linear low density polyethylene resin in a post-polymerization reactor finishing process; pelletizing the blend of PPA and linear low density polyethylene resin; and, extruding the blend into a blown film or cast film on an extrusion line, wherein the polymer processing aid is a polyphosphite, a polysiloxane, a polyethylene glycol, a high MFR polypropylene, a high MFR polybutene-1, a metal salt of a fatty acid, a polyamide, or a boron nitride; and wherein the blown film or cast film is such that at 90 minutes of forming the blown film or cast film, % melt fracture (on basis of area of the film's surface) is less than equal to 35%.

In yet another form of the present disclosure, provided is a method of decreasing melt fracture in a polyethylene pipe comprising: extruding a polyethylene resin into a pipe on an extrusion line; and blending into the extrusion line a polymer processing aid (PPA) that is substantially free of fluorine-containing compounds to provide from 100 ppm to 10,000 ppm of the polymer processing aid (PPA) in the blown film or cast film, wherein the polymer processing aid is a polyphosphite, a polysiloxane, a polyethylene glycol, a high MFR polypropylene, a high MFR polybutene-1, a metal salt of a fatty acid, a polyamide, or a boron nitride. Alternative, another form of the present disclosure provided is a method of decreasing melt fracture in linear low density polyethylene comprising: extruding a linear low density polyethylene resin into a wire and cable sheath or covering on an extrusion line; and blending into the extrusion line a polymer processing aid (PPA) that is substantially free of fluorine-containing compounds to provide from 100 ppm to 10,000 ppm of the polymer processing aid (PPA) in the blown film or cast film, wherein the polymer processing aid is a polyphosphite, a polysiloxane, a polyethylene glycol, a high MFR polypropylene, a high MFR polybutene-1, a metal salt of a fatty acid, a polyamide, or a boron nitride.

### BRIEF DESCRIPTION OF THE DRAWINGS

These and other features, aspects, and advantages of the present invention will become better understood with reference to the following description and appended claims, and accompanying drawings where:

FIG. 1 is a graph showing the observed melt fracture % over time for certain trial LLDPE films produced using various inventive PPA compositions and a comparative (control) fluorine containing PPA composition in connection with the examples.

FIG. 2 is a table of the observed melt fracture % over time data for the certain trial LLDPE films of FIG. 1.

FIG. 3 is a graph showing the observed melt fracture % over time for certain other trial LLDPE films produced using various inventive PPA compositions and a comparative (control) fluorine containing PPA composition in connection with the examples.

FIG. 4 is a table of the observed melt fracture % over time data for the certain other trial LLDPE films of FIG. 3.

FIG. 5 is a graph showing the observed melt fracture % over time for certain still other trial LLDPE films produced using various inventive PPA compositions in connection with the examples.

FIG. 6 is a table of the observed melt fracture % over time data for the certain still other trial LLDPE films of FIG. 5.

FIG. 7 is a graph showing the observed melt fracture % over time for certain yet still other trial LLDPE films produced using various inventive PPA compositions in connection with the examples.

FIG. 8 is a table of the observed melt fracture % over time data for the yet certain still other trial LLDPE films of FIG. 7.

FIG. 9 is a graph showing the observed melt fracture % over time for certain yet still more other trial LLDPE films produced using various inventive PPA compositions in connection with the examples.

FIG. 10 is a table of the observed melt fracture % over time data for the certain yet still more other trial LLDPE films of FIG. 9.

FIG. 11 is a graph showing the observed melt fracture % over time for 1% of Tegomer H-Si 6441 P masterbatch (multifunctional polyester modified siloxane) in LLDPE films.

It should be understood that the various embodiments are not limited to the arrangements and instrumentality shown in the drawings.

### DETAILED DESCRIPTION OF THE INVENTION

The present disclosure relates to LLDPE compositions, including pellets, blown films and cast films, containing inventive polymer processing aids (PPAs) to help decrease and eliminate melt fracture during film processing. The LLDPE compositions containing the PPAs provided herein are substantially free of fluoropolymer compounds. Also provided are polyolefin masterbatches including such inventive PPAs. Still also provided are methods of making such LLDPE compositions containing non-fluorinated PPAs and methods of decreasing melt fracture in linear low density polyethylene films produced with such inventive PPAs.

It has been surprisingly and unexpectedly discovered that certain non-fluorine containing compounds decrease melt fracture % in blown LLDPE films and cast LLDPE films during extrusion processing. More particularly, polyphosphites, polysiloxanes, polyethylene glycols, high MFR polypropylene, high MFR polybutene-1, metal salts of fatty acids, polyamides, and boron nitride have been surprisingly discovered to be highly effective as polymer processing aids relative to traditional fluoropolymer-based polymer processing aids. In particular, the inventive PPAs disclosed herein when incorporated into LLDPE blown film and LLDPE cast film during extrusion processing result in a blown film or cast film such that at 90 minutes of forming the blown film or cast film, % melt fracture (on basis of area of the film's surface) is less than equal to 90%, or less than or equal to 80%, or less than or equal to 70%, or less than or equal to 60%, or less than or equal to 50%, or less than or equal to 40%, or less than or equal to 35%, or less than or equal to 30%, or less than or equal to 25%, or less than or equal to 20%, or less than or equal to 15%, or less than or equal to 10%, or less than or equal to 5%, or less than or equal to 1%, or 0% (no melt fracture whatsoever). Alternatively, the inventive PPAs disclosed herein decrease melt fracture % when incorporated into polyethylene that is extruded as a pipe, or wire and cable sheath or covering.

The details of the inventive PPAs, polyolefin masterbatches including such inventive PPAs, LLDPE compositions including such inventive PPAs, methods of making such LLDPE compositions and polyolefin masterbatches, and methods of decreasing melt fracture in linear low density polyethylene films are provided below.

### Definitions

For the purposes of the present disclosure, various terms are defined as follows.

The term “alpha-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alpha-olefin” is an alpha-olefin wherein R¹ is hydrogen and R² is hydrogen or a linear alkyl group. For the purposes of the present disclosure, ethylene shall be considered an α-olefin.

The term “extrusion” or “extruding” refers to processes that include forming a polymer and/or polymer blend into a melt, such as by heating and/or shear forces, and then forcing the melt out of a die in a form or shape such as in a film, or in strands that are pelletized. Typical extrusion apparatus includes a single-screw extruder or twin-screw extruder, or other melt-blending device as is known in the art and that can be fitted with a suitable die. It will also be appreciated that extrusion can take place as part of a polymerization process (in particular, in the finishing portion of such process) as part of forming polymer product (such as polymer pellets); or it can take place as part of the process for forming articles such as films from the polymer pellets (e.g., by at least partially melting the pellets and extruding through a die to form a sheet, especially when combined with blowing air such as in a blown film formation process). In the context of the present disclosure, extrusion in the finishing portion of polymerization processes may be referred to as compounding extrusion, and typically involves feeding additives plus additive-free (reactor grade) polymer to the extruder; while extrusion of polymer to make articles (e.g., extrusion of polymer pellets to make films) takes place downstream (e.g., at a later point, after polymer product has been formed including through compounding extrusion), and typically involves feeding optional additives plus additive-containing polymer to the extruder.

The term “finishing” refers to post-polymerization reactor processing steps where additives, such as PPAs, may be incorporated into the LLDPE polymer to form a finished polymer product, such as LLDPE pellets or resin, with one example of a finishing process being the compounding extrusion just discussed. Finishing occurs prior to further processing of the finished LLDPE polymer product (resin or granules) into articles such as films.

The term “LLDPE” refers to a linear-low density polymer containing a copolymer of ethylene and one or more a-olefins polymerized in the presence of one or more single-site catalysts, such as one or more Ziegler-Natta catalysts, one or more metallocene catalysts, and combinations thereof. Such LLDPE can have density within the range from a low of 0.900, 0.905, 0.907, 0.910 g/cm3 to a high of 0.920, 0.925, 0.930, 0.935, 0.940, to a high of 0.945 g/cm³. In particular embodiments, the LLDPE includes a metallocene-catalyzed LLDPE (mLLDPE). In yet other embodiments, the LLDPE includes a Ziegler-Natta catalyzed LLDPE (or ZN-LLDPE). LLDPE can be produced in gas, slurry, or solution phase polymerization, and some particularly preferred LLDPEs can be produced in gas or slurry phase polymerization.

The term “LLDPE composition” refers to a composition containing a LLDPE polymer. The LLDPE polymer composition can be in any form. Some examples include: the form of a reactor grade (e.g., granules or resin) containing the LLDPE polymer; the form of a molten or at least partially molten composition containing the LLDPE polymer and one or more additives undergoing or about to be undergoing the process of finishing (such as in the process of compounding extrusion), which is may be referred to as a pre; in the form of a finished LLDPE polymer product such as LLDPE polymer pellets containing the LLDPE and any additives (such as PPA); or in the form of a finished LLDPE product such as LLDPE resin undergoing the process of mixing (e.g., via coextrusion, melt blending, or other processing) with additives, such as in the case of LLDPE being extruded to form blown film, cast film or other polymer-containing article.

The term “masterbatch” refers to a powdered, granulate, or pelletized composition comprising a mixture of two or more components that is used to simplify forming a product comprising the two components, rather than forming the product from the individual components. In addition, as used herein, the term encompasses both concentrated compositions, which are formulated to be mixed with one or more diluting components during the formation of the polymer product, or “fully” compounded compositions, which are not formulated to be mixed with such diluents. Unless context otherwise suggests, the phrase “MB” is used herein to denote “masterbatch.”

The term “melt fracture” refers to a mechanically-induced melt flow instability which occurs, e.g., at the exit of an extrusion die and typically in conditions of high shear rate. Pinhole, linear, and annular die geometries are among those that can induce melt fracture. There are different mechanical regimes that describe LLDPE melt fracture, but all manifest as a very rough polymer surface which persists as the polymer crystallizes. Commonly in the blown film processing, a rough array of sharkskin like patterns develop on the film surface, often with a characteristic size from the mm to cm scale, and they depend on both the flow profile and rheology of the LLDPE polymer.

The term “polyolefin” refers to polymers (including biopolymers) formed from at least one simple olefin (with the general formula CₙH₂ₙ) as a monomer, and includes both homopolymers and copolymers, (e.g., bipolymers, terpolymers, etc.), and blends thereof. In addition, they include polymers of ethylene (i.e., polyethylene), which include LDPE, LLDPE, MDPE, HDPE, copolymers of ethylene with one or more alpha-olefins, copolymers of ethylene with a vinyl ester comonomer, and blends thereof. They also include polymers of propylene (i.e., polypropylene), copolymers (e.g., bipolymers, terpolymers, etc.) of propylene with one or more alpha-olefins, and blends of different polyolefins. They also include polymers of butylene (i.e., polybutene), copolymers (e.g., bipolymers, terpolymers, etc.) of butylene with one or more alpha-olefins, and blends of different polyolefins.

### Polymer Processing Aids (PPAs)

The present disclosure provides for inventive PPAs that may be incorporated into LLDPE compositions to improve their processing and productivity performance, as well as the quality of products in terms of visual appearance (e.g. blown films, cast films, etc.) that may be made from such LLDPE compositions. The inventive PPAs may be incorporated or blended into the LLDPE as part of a finishing step after the polymerization process or alternatively may be incorporated into LLDPE during the subsequent converting step to form a finished product, such as a blown film or a cast film. The PPAs and the corresponding LLDPE compositions incorporating such PPAs of the present disclosure are “substantially free” of fluoropolymer compounds, which means that the LLDPE compositions may include trace amounts (e.g., 10 ppm or less, preferably 1 ppm or less, such as 0.1 ppm or less) of fluorine, e.g., as an impurity, but well below the amount that would intentionally be included in a polymer composition via such additives (e.g., about 100 ppm of fluorine atoms by mass of polymer product in a typical case where such additives are included). The inventive PPAs of the present disclosure include the following classes of materials, which are described in detail below:

### 1. Polyethylene Glycol Based PPAs

Polyethylene glycols (PEGs) have been discovered as a class of compounds that function effectively as PPAs in LLDPE compositions. The LLDPE compositions disclosed herein may include one or more PEG-based compositions. The LLDPE-based PPA composition can comprise at least 2 wt. % PEG, or at least 5 wt. % PEG, or at least 10 wt. % PEG, or at least 20 wt. % PEG, such as at least 30 wt. %, or at least 40 wt. % PEG where the LLDPE-based PPA composition is in the form of a masterbatch. In particular embodiments, the PEG-based PPA can consist of or consist essentially of PEG or a PEG masterbatch (where “consist essentially of”, in this context, permits up to 1 wt. %, more preferably 0.5 wt. % or less, most preferably 0.1 wt. % or less, of impurities, where the impurities preferably do not include fluorine or any fluorine-containing compound). In other embodiments, the PEG-based PPA composition can comprise PEG at loading of 2, or 5, or 10, or 20, or 30, or 40 to 60, or 70, or 80, or 90, or 95, or 98 wt. % (on the basis of total mass of PPA composition), and one or more PPA blend partners at a loading within a range from 2, or 5, or 10, or 20, or 30, or 40 wt. % to 60, or 70, or or 80, or 90, or 95, or 98 wt. % (on the basis of total mass of PPA composition, with ranges from any foregoing low end to any foregoing high end contemplated).

Polyethylene glycol having a weight-average molecular weight ranging from 4,000 to 15,000, or 6,000 to 13,000, or 8,000 to 11,000 are particularly useful as PPAs, and for most LLDPE polymers, the PEG can be deployed without other components, especially without fluorine-based components. Thus, a PEG PPA of the present disclosure comprises at least 80 wt. % PEG or PEG masterbatch, more preferably at least 90 wt. % PEG or PEG masterbatch, such as at least 95 wt. % or at least 99 wt. % PEG or PEG masterbatch; alternatively the PEG PPA may be said to consist or consist essentially of PEG or PEG masterbatch (where “consist essentially of” in this context means that other components are not intentionally included, but allows for trace amounts, e.g., 100 ppm or less, preferably 50 ppm or less, or even 10 or 1 ppm or less, of impurities, and further wherein such impurities do not include fluorine or fluorine-containing compounds).

As used herein, polyethylene glycol or PEG refers to a polymer expressed as H—(O—CH₂—CH₂)ₙ—OH, where n represents the number of times the O—CH₂—CH₂ (oxyethylene) moiety is repeated; n can range widely, because PEG comes in a wide variety of molecular weights. For instance, n can be about 33 for lower-molecular weight polyethylene glycols (˜1500 g/mol), ranging up to about 227 for higher molecular weight polyethylene glycols (10,000 g/mol) such as about 454 for 20,000 g/mol molecular-weight PEG; and 908 for 40,000 molecular-weight PEG; and even higher for higher-molecular-weight PEG varieties. It is also noted that PEG can equivalently be referred to as polyethylene oxide (PEO) or polyoxyethylene (POE). Sometimes in industry parlance, PEG is the nomenclature used for relatively lower molecular weight varieties (e.g., molecular weight 20,000 g/mol or less), while polyethylene oxide or PEO is used for higher-molecular-weight varieties (e.g., above 20,000 g/mol). However, for purposes of the present disclosure, references to polyethylene glycol or PEG should not, alone, be taken to imply a particular molecular weight range, except where a molecular weight range is explicitly stated. That is, the present application may use the terms polyethylene glycol or PEG to refer to a polymer having structure H—(O—CH₂—CH₂)ₙ—OH with n such that the polymer's molecular weight is less than 20,000 g/mol, and it may also use the terms polyethylene glycol or PEG to refer to such a polymer with n such that the polymer's molecular weight is greater than 20,000 g/mol, such as within the range from 20,000 to 40,000 g/mol.

PEG “molecular weight” as used herein refers to weight-average molecular weight (Mw) as determined by gel permeation chromatography (GPC), and PEG “molecular weight distribution” or MWD refers to the ratio of Mw to number-average molecular weight (Mn), i.e., Mw/Mn. PEG compositions for use in PPAs may advantageously have narrow MWD, such as within the range from a low of any one of about 1.0, 1.1, 1.2, 1.3, 1.4, or 1.5 to a high of any one of about 1.1, 1.2, 1.3, 1.4, 1.5, 1.6, 1.7, 1.8, 1.9, 2.0, 2.5, or 3.0, with ranges from any foregoing low end to any foregoing high end contemplated, provided the high end is greater than the low end (e.g., 1.0 to 2.0, or 1.0 to 1.5, such as 1.0 to 1.2 or even 1.0 to 1.1). For instance, PEG compositions having MWD of about 1 to 1.1 or 1.2 may be particularly useful. However, obtaining such a uniform length of polymer chains (i.e., narrow MWD) can be expensive; thus, commercially available PEG compositions might have broader MWD values (e.g., ranging from 1 to 3, 4, 5, or even greater). Such PEG compositions are therefore also within the scope of the present disclosure. These PEG compositions can still suitably be employed as PPAs, potentially (but not necessarily) compensating by increasing the PEG loading for such broader-MWD PEGs (e.g., 700-1400 ppm, as compared to loadings as low as 400-700 ppm for narrower-MWD PEGs). PEG-based PPA loading is discussed in more detail below.

In embodiments employing narrow MWD PEG, Mw values for PEG will commonly be in relatively close agreement with Mn (e.g., within 10%); regardless, however, where differences between the two (Mw and Mn) exist, Mw should control as the preferred “molecular weight” measurement for purposes of the present disclosure. It is also noted that many commercial PEG compounds include a nominal molecular weight (e.g., “PEG 3K” or “PEG 10K” indicating nominal 3,000 g/mol and 10,000 g/mol molecular weights, respectively). Again, Mw of the PEG should control over any contrary nominal indicator.

Polyethylene glycols suitable for use in PEG-based PPAs herein generally can include PEG of a variety of molecular weights, potentially including PEG having Mw ranging from as low as 500 g/mol to as high as 200,000 g/mol, such as from a low of any one of 500, 600, 700, 800, 900, 1000, 3000, 5000, 7000, or 7500 g/mol to a high of 40000, 50000, 60000, 75000, 80000, 90000, 100000, 125000, 150000, 175000, or 200000 g/mol, with ranges from any low end to any high end contemplated.

In certain embodiments, however, particularly preferred PEGs are those having molecular weight less than 40,000 g/mol; such as within the range from a low of any one of 500, 600, 700, 800, 900, 1000, 1500, 2000, 2500, 3000, 3500, 4000, 4500, 5000, 5500, 6000, 7000, 8000, 8500, 9000, 9500, 10000, 12500, and 15000 g/mol to a high of any one of 7000, 7500, 8000, 8500, 9000, 9500, 10000, 10500, 11000, 11500, 12000, 12500, 15000, 20000, 22000, 25000, 30000, 35000, 39000, and 39500 g/mol, provided the high end is greater than the low end, and with ranges from any foregoing low end to any foregoing high end generally contemplated (e.g., 1,500 to 35,000 g/mol, or 5,000 to 20,000 g/mol, such as 5,000 to 12,000 g/mol or 6,000 to 12,000 g/mol). Particularly higher or lower sub-ranges may also be suitable (e.g., PEG having Mw of 1,500 to 5,500 g/mol; or PEG having Mw of 5,000 to 12,000 g/mol; or PEG having Mw of 10,000 to 20,000 g/mol; or PEG having Mw of 15,000 to 25,000 g/mol; or PEG having Mw of 25,000 to 35,000 g/mol).

Further, it is also contemplated that blends of multiple of the aforementioned PEG compounds could form a suitable PPA. For instance, a PEG-based PPA can comprise at least 90 wt. %, preferably at least 99 wt. %, of a blend of two or more polyethylene glycols, for instance any two or more of: a first PEG having molecular weight within the range from 3,000 to 7,000 g/mol; a second PEG having molecular weight within the range from 5,000 to 12,000 g/mol; a third PEG having molecular weight within the range from 10,000 to 20,000 g/mol; and a fourth PEG having molecular weight within the range from 20,000 to 40,000 g/mol, provided that each of the first, second, third, and fourth PEG of such blends have different molecular weights from the other polyethylene glycol(s) of those blends. And, in some embodiments, a higher-molecular weight PEG could be included in such blend (e.g., one or more PEGs having molecular weight greater than 40,000 g/mol).

However, as noted, it is contemplated that PEG-based PPA compositions of many embodiments as described herein do not include polyethylene glycol (or polyethylene oxide) having molecular weight greater than 40,000 g/mol. That is, it is preferred that all or substantially all polyethylene glycol of the polymer compositions has molecular weight less than 40,000 g/mol; such as less than 35,000 g/mol, or less than 33,000 g/mol, or less than 22,500 g/mol, or less than 20,000 g/mol, or less than 12,000 g/mol, such as less than 10,000 g/mol. In this context, “substantially all” means that minor amounts (50 ppm or less, more preferably 10 ppm or less, such as 1 ppm or less) of higher-molecular weight PEG could be included while not losing the effect of including predominantly the lower-molecular-weight PEGs described herein. Put equivalently, the PEG having molecular weight greater than 40,000 g/mol is absent or substantially absent from the polymer compositions. It is believed that the focus on lower molecular-weight PEG enables generally lower loadings of the PEG-based PPA to achieve the desired elimination of melt fractures across most grades of LLDPE polymer that might experience melt fracture when formed into blown films. Similarly, lower molecular-weight PEG is believed to diffuse faster to the surface of polymer material being extruded in, e.g., blown film processes, as compared to higher molecular weight varieties of PEG; therefore, the lower molecular-weight PEG varieties will typically lead to faster elimination of melt fracture in blown LLDPE films (and therefore lower off-spec production). However, it is nonetheless contemplated that higher-molecular weight PEG (e.g., Mw>40,000 g/mol) may be appropriate in some cases for certain LLDPE polymer grades, despite the above-noted advantages of lower-molecular weight PEG; hence the contemplation that such higher-molecular weight PEGs may be included in LLDPE compositions that are still within the spirit and scope of some embodiments of the present invention.

The PEG PPAs disclosed herein may be incorporated into the LLDPE compositions at loadings of from 100 to 10,000 ppm, or 200 to 8000 ppm, or 300 to 5000 ppm, or 500 to 2000 ppm, or 800 to 1500 ppm. Alternatively, the PEG PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary polyolefin carrier resins for the resin masterbatches include LLDPE, LDPE, MDPE, HDPE, PP, PB-1, and various copolymers and terpolymers of ethylene, propylene and butylene.

Commercially available examples of suitable polyethylene glycols, especially those of lower molecular weight, include: Pluriol® E 1500; Pluriol® E 3400; Pluriol® E 4000; Pluriol® E 6000; Pluriol® E 8000; and Pluriol® E 9000 polyethylene glycols available from BASF (where the numbers represent nominal molecular weights of the PEG); also include Carbowax™ PEG 8000, and Carbowax™ PEG 400 available from Dow; and also includes Polyglykol 8000S PEG from Clariant.

### 2. Metal Salts of Fatty Acids Based PPAs

Metal salts of fatty acids have been discovered as a class of compounds that function effectively as PPAs in LLDPE compositions. Fatty acids, as used herein, refer to carboxylic acid (formula R*—COOH, where R is alkyl or alkenyl), wherein R* is C₈ or greater (meaning the alkyl or alkenyl group comprises at least 4 carbon atoms). Preferably, R* is an aliphatic carbon chain having at least 4 carbons, such as at least 6 or at least 8 carbon atoms. It can be saturated or unsaturated (and, where unsaturated, can have one or more unsaturations). Examples include the following, where R*'s value is denoted as saturated carbon chains unless otherwise specifically noted to have one or more unsaturations: caprylic acid (where R* is C₇), capric acid (R* is C₉), lauric acid (R* is C₁₁), myristic acid (R* is C₁₃), palmitic acid (R* is C₁₅), oleic acid (R* is C₁₇, with a monounsaturation), stearic acid (R* is C₁₇), arachidic acid (R* is C₁₉), arachidonic acid (R* is C₁₉ with multiple unsaturations), crucic acid (R* is C₂₁, with a monounsaturation), behenic acid (R* is C₂₁), lignoceric acid (R* is C₂₃), and cerotic acid (R* is C₂₃).

A variety of suitable metals for forming a salt with the fatty acid may be utilized, including, but not limited to, those of Groups 1 or 2 of the Periodic Table of the Elements (e.g., lithium, sodium, potassium, beryllium, magnesium, calcium). Also contemplated are metals with different valence such as aluminum and zinc. Non-limiting exemplary metal salts include metal stearates, such as zinc stearate, calcium stearate, and combinations thereof (although also contemplated are stearates of any other metal noted above). Zinc stearate and calcium stearate may be advantageous as PPAs in LLDPE because their use in polymer compositions already as a heat stabilizer and lubricant, although it has not yet been used as such a major blend component in a fluorine-free PPA for LLDPE compositions.

The metal salts of fatty acids PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the metal salts of fatty acids PPAs disclosed herein may be incorporated into the LLDPE compositions as a resin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, PB-1; and various copolymers and terpolymers of ethylene, propylene and butylene.

Commercially available examples of suitable metal salts of fatty acids PPAs include: zinc stearate (CAS: 557-05-1), which may be purchased from Silver Fern Chemical Inc., and calcium stearate (CAS: 1592-23-0), which may also be purchased from Silver Fern Chemical Inc.

### 3. Silicone (Polysiloxane) Based PPAs

Silicone based PPAs have also been discovered as a class of compounds that function effectively as PPAs in LLDPE compositions. In particular, high molecular weight silicones, also referred to as polysiloxanes, are advantageous as PPAs. Polysiloxanes include organic substituents, e.g., [(CH₃)₂SiO]ₙ and [(C₆H₅)₂SiO)]ₙ. All polymerized siloxanes or polysiloxanes, silicones consist of an inorganic silicon-oxygen backbone chain (. . . —Si—O—Si—O—Si—O— . . . ) with two groups attached to each silicon center. By varying the —Si—O— chain lengths, side groups, and crosslinking, silicones can be synthesized with a wide variety of properties and compositions. Particularly advantageous as PPAs for LLDPE compositions are silicone materials based on silicone resins, which are formed by branched and cage-like oligosiloxanes.

In one form, the silicone based PPAs may be polyester modified having the formula:

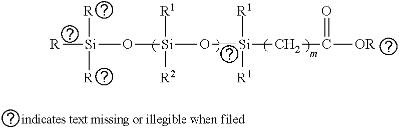

wherein: R¹ are independently selected from the group consisting of: an alkyl having 1-5 carbon atoms, a substituted alkyl having 1-5 carbon atoms optionally substituted by a phenyl, and R² is selected from the group consisting of: hydrogen, alkyl of 1 to 45 carbon atoms, substituted alkyl of 1 to 45 carbon atoms optionally substituted by one or more aryl, a partially esterified ester-containing group represented by the formula:

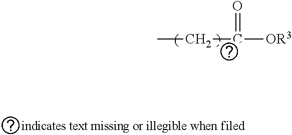

and a reverse ester thereof represented by the formula:

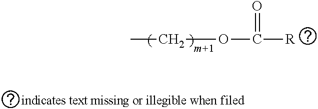

and the formula:

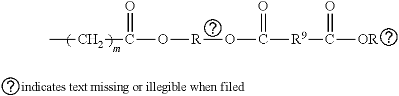

and a reverse ester thereof represented by the formula:

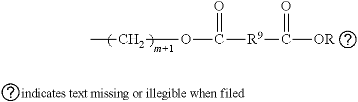

provided that if R¹ is anything but methyl or ethyl, then R² must be a methyl, ethyl or butyl. R³ is derived from a partially esterified ester residue; R⁸ is selected from the group consisting of hydrogen, alkyl of 1 to 45 carbon atoms, substituted alkyl of 1 to 45 carbon atoms optionally substituted by an aryl and a compound derived from a partially esterified ester residue; R⁹ is selected from the group consisting of: an arylene, an alkylene of 1 to 22 carbon atoms, substituted alkylene of 1 to 22 carbon atoms optionally substituted by an arylene; R⁴ is selected from the group consisting of: alkyl of 1 to 45 carbon atoms, substituted alkyl of 1 to 45 carbon atoms optionally substituted by an aryl, the ester-containing group and the compound derived from reverse esters thereof, in is an integer between about 5 to about 22; and x is an integer between about 0 to about 1000; wherein the composition has at least 1 compound derived from the partially esterified ester-containing group or the reverse ester thereof.

In another form, the silicone based PPAs may be a polydimethylsiloxane (PDMS) having the general formula: CH₃[Si(CH₃)₂O]ₙSi(CH₃)₃, where n is the number of repeating monomer [Si(CH₃)₂O] units.

The silicone based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the silicone based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, PB-1, and various copolymers and terpolymers of ethylene, propylene and butylene.

Commercially available examples of suitable silicone based PPAs include: Tegomer H-Si 6441 P (multifunctional polyester modified siloxane in thermoplastic resins), Polymer Dynamix Everglide PA45 (functional siloxane in PE carrier resin), Dow Corning MB-001 Masterbatch (50% ultra-high molecular weight siloxane in homopolymer PP carrier resin), Dow Corning MB-002 Masterbatch (50% ultra-high molecular weight siloxane in LDPE carrier resin), Dupont Multibase MB25-035 Masterbatch (siloxane polymer in LDPE carrier resin), and Dupont Multibase MB25-235 Masterbatch (siloxane polymer in LDPE carrier resin).

### 4. High Melt Flow Rate Polypropylene Based PPAs

High melt flow rate polypropylene (PP) based PPAs have also been discovered as a class of compounds that function effectively as PPAs in LLDPE compositions. The high melt flow rate polypropylene may include copolymers with ethylene and/or butylene, although homopolymer PP is advantageous.

Suitable polypropylene includes propylene homopolymers and random copolymers with ethylene or other α-olefins. Propylene homopolymers can be isotactic, syndiotactic, or atactic, or mixtures thereof. In at least one embodiment, isotactic polypropylene is preferred because of its crystalline nature. Suitable random polypropylene copolymers include propylene-ethylene copolymers and propylene-C4 to C10 α-olefin copolymers. Examples of C4 to C10 α-olefins include 1-butene, 1-hexene and 1-octene. propylene-ethylene copolymers contain 1 to 20 wt. % recurring units of ethylene. Propylene-ethylene copolymers may contain 1 to 10 wt. % recurring units of ethylene.

“High melt flow rate” for the purposes of polypropylene of this disclosure corresponds to a melt flow rate as measured by ASTM D1238 or ISO 1133-1 of at least 200 g/10 min, or at least 400 g/10 min, or at least 600 g/10 min, or at least 800 g/10 min, or at least 1000 g/10 min, or at least 1200 g/10 min, or at least 1400 g/10 min, or at least 1600 g/10 min, or at least 1800 g/10 min. “High melt flow rate” for the purposes of polypropylene of this disclosure also corresponds to a melt flow rate as measured by ASTM D1238 or ISO 1133-1 of less than 4000 g/10 min, or less than 3500 g/10 min, or less than 3000 g/10 min, or less than 2500 g/10 min, or less than 2000 g/10 min. Generally ISO 1133-1 is the preferred test method of measuring MFR of extremely high melt flow rate polypropylenes.

The high MFR PP based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the high MFR PP based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, PB-1, and various copolymers and terpolymers of ethylene, propylene and butylene.

Commercially available examples of suitable high MFR PP based PPAs include LyondellBasell Metocene MF650W (PP homopolymer of 500 MFR) and LyondellBasell Metocene MF650X (PP homopolymer of 1200 MFR).

### 5. High Melt Flow Rate Polybutene-1 Based PPAs

High melt flow rate polybutene-1 (PB-1) based PPAs have also been discovered as a class of compounds that function effectively as PPAs in LLDPE compositions. PB-1 may be used as homopolymer or as a random copolymer including one or more other alpha-olefins at a comonomer content of from 1 to 20 wt. %, although homopolymer PB-1 is advantageous for this disclosure. In particular, semi-crystalline homopolymer of polybutene-1 of high melt flow rate are effective as PPAs in LLDPE compositions.

“High melt flow rate” for the purposes of PB-1 of this disclosure corresponds to a melt flow rate as measured by ISO 1133-1 of at least 100 g/10 min, or at least 200 g/10 min, or at least 300 g/10 min, or at least 400 g/10 min, or at least 600 g/10 min, or at least 800 g/10 min, or at least 1000 g/10 min, or at least 1200 g/10 min, or at least 1400 g/10 min. “High melt flow rate” for the purposes of PB-1 of this disclosure also corresponds to a melt flow rate as measured by ASTM D1238 or ISO 1133-1 of less than 4000 g/10 min, or less than 3500 g/10 min, or less than 3000 g/10 min, or less than 2500 g/10 min, or less than 2000 g/10 min, or less than 1500 g/10 min. Generally ISO 1133-1 is the preferred test method of measuring MFR of extremely high melt flow rate polybutenes.

The high MFR PB-1 based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the high MFR PB-1 based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, and various copolymers and terpolymers of ethylene, propylene and butylene.

Commercially available examples of suitable high MFR PB-1 based PPAs include LyondellBasell Koattro PB M 0600M (homopolymer of 600 MFR) and LyondellBasell Koattro PB 0801M (homopolymer of 200 MFR).

### 6. Polyphosphite Based PPAs

Homopolymeric, copolymeric and cycloaliphatic polyphosphites have also been discovered as a class of compounds that function effectively as PPAs in LLDPE compositions.

In one form, the polyphosphite PPA may be a homopolymeric polyphosphite containing from 15 to 1000 repeating units of the formula:

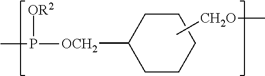

in which R² is selected from the group consisting of C₁₋₂₀ alkyl, C₃₋₂₂ alkenyl, and C₂₋₂₀ polyalkylene glycol chain terminated by a C₁₋₄ alkyl group. The polyphosphite is terminated adjacent the —P(OR²)— group of the formula above by a group R¹O—, and terminated at the other end of the chain by a group —P(OR³)(OR⁴), in which each of R¹, R³, and R⁴, which may be the same or different, has one of the meanings given for R². The homopolymeric polyphosphite may have a weight average molecular weight from 6,000 to 100,000. The C₂₋₂₀ polyalkylene glycol chain may be terminated by a C₁₋₄ alkyl group selected from the group consisting of a polyethylene glycol terminated by a methyl group and a tripropylene glycol terminated by a butyl group. Alternatively, the R² may be a C₁₀₋₂₀ alkyl group. The homopolymeric polyphosphite PPA depicted above may be blended with a polyolefin polymer to form a polymer composition. One non-limiting exemplary polyolefin polymer is polyethylene, and more particularly LDPE or LLDPE.

In another form, the polyphosphite PPA may be a copolymeric polyphosphite containing from 2 to 1000 repeating units of the formula:

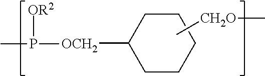

in which R² is selected from the group consisting of C₁₋₂₀ alkyl, C₃₋₂₂ alkenyl, C₆₋₄₀ cycloalkyl, C₆ aryl, C₆₋₄₀ aryl alkyl and Y—OH; and from 1 to 1000 repeating units of the formula:

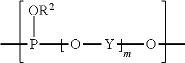

in which: Y is selected from the group consisting of C₂₋₄₀ alkylene, C₂₋₄₀ alkyl lactone, C₃₋₄₀ cycloalkylene, C₆ arylene and C₆₋₄₀ aryl alkylene; m ranges from 5 to 20; said copolymeric polyphosphite being terminated adjacent the —P(OR²)— group of the formula above by a group R¹O—, and terminated at the other end of the chain by a group —P(OR³)(OR⁴), in which each of R¹, R³, and R⁴, which may be the same or different and has one of the meanings given for R². Alternatively, the R² may be a C₆-C₁₀ cycloalkyl or the R² may be a C₁₀₋₂₀ alkyl group. The copolymeric polyphosphite PPA depicted above may be blended with a polyolefin polymer to form a polymer composition. One non-limiting exemplary polyolefin polymer is polyethylene, and more particularly LDPE or LLDPE.

In another form, the polyphosphite PPA may be a polymeric polyphosphite containing from 2 to 1000 repeating units of the formula:

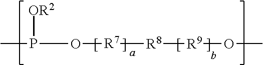

in which: R² is derived from a monohydroxy alcohol R²—OH end-capping group and is selected from the group consisting of a C₁₋₂₀ alkyl group, a C₃₋₂₂ alkenyl group, a C₆₋₄₀ cycloalkyl, a C₆ aryl, a C₆₋₄₀ aryl alkyl and Y—OH; R⁷ and R⁹ are methylene groups; R⁸ is a cyclohexylene group; a and b are 1; and from 1 to 1000 repeating units of the formula:

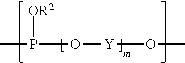

in which: Y is selected from the group consisting of a C₂₋₄₀ alkylene group, a C₂₋₄₀ alkyl lactone, a C₃₋₄₀ cycloalkylene group, a C⁶ arylene group and a C₆₋₄₀ aryl alkylene; m ranges from 5 to 20; said polyphosphite being terminated adjacent the —P(OR²)— group of the formula above by a group R¹O—, and terminated at the other end of the chain by a group —P(OR³)(OR⁴), in which each of R¹, R³, and R⁴, which may be the same or different, has one of the meanings given for R². Alternatively, the R² may be a C₁₀₋₂₀ alkyl group. The polyphosphite PPA depicted above may be blended with a polyolefin polymer to form a polymer composition. One non-limiting exemplary polyolefin polymer is polyethylene, and more particularly LDPE or LLDPE.

In another form, the polyphosphite PPA may be a copolymeric polyphosphite which comprises two different repeat units —O—Y—:

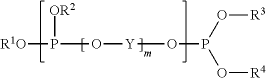

wherein each R¹, R², R³ and R⁴ can be the same or different and independently selected from the group consisting of C₁₋₂₀ alkyl and C₃₋₂₂ alkenyl; each Y is independently selected from two of the group consisting of C₂₋₄₀ alkylene and C₂₋₄₀ alkyl lactone esters; m is an integral value ranging from 2 to 100 inclusive; and x is an integral value ranging from 12 to 30. Alternatively, the above copolymeric phosphite includes polyalkylene glycol segments between the phosphite moieties, wherein the polyalkylene glycol segments are selected from the group consisting of polyethylene glycol segments and polypropylene glycol segments. The copolymeric polyphosphite PPA depicted above may be blended with a polyolefin polymer to form a polymer composition. One non-limiting exemplary polyolefin polymer is polyethylene, and more particularly LDPE or LLDPE.

The polyphosphite based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the polyphosphite based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, and various copolymers and terpolymers of ethylene, propylene and butylene.

Commercially available examples of suitable polyphosphite based PPAs include Songwon Songnox PQ, Dover LGP-11, and Dover LPG-12, as well as masterbatches of Dover LGP-11 (PP carrier), and Dover LPG-12 (LLDPE carrier or PP carrier).

### 7. Boron Nitride Based PPAs

Boron Nitrides (BN) have also been discovered as a class of compounds that function effectively as PPAs in LLDPE compositions. BN is a thermally and chemically resistant refractory compound of boron and nitrogen, which exists in various crystalline forms that are isoelectronic to a similarly structured carbon lattice. The hexagonal form corresponding to graphite is the most stable and soft among BN polymorphs and because of its good lubricant properties, is particularly advantageous as a BN PPA. Alternative forms are the cubic form (zincblende, aka sphalerite structure), which is analogous to diamond and is called c-BN, although it is softer than diamond, but its thermal and chemical stability is superior. The rare wurtzite BN modification is similar to lonsdaleite, but slightly softer than the cubic form.

For the purposes of this disclosure as a PPA, the hexagonal form (h-BN) of BN is particularly advantageous. h-BN is the most stable crystalline form and is also called h-BN, α-BN, g-BN, and graphitic boron nitride. Hexagonal boron nitride (point group=D₆ₕ; space group=P6₃/mmc) has a layered structure similar to graphite. Within each layer, boron and nitrogen atoms are bound by strong covalent bonds, whereas the layers are held together by weak van der Waals forces. The interlayer “registry” of these sheets differs, however, from the pattern seen for graphite, because the atoms are eclipsed, with boron atoms lying over and above nitrogen atoms. This registry reflects the local polarity of the B—N bonds, as well as interlayer N-donor/B-acceptor characteristics. Likewise, many metastable forms consisting of differently stacked polytypes exist. Therefore, h-BN and graphite are very close neighbors, and the material can accommodate carbon as a substituent element to form BNCs. BC₆N hybrids have been synthesized, where carbon substitutes for some B and N atoms. Hexagonal BN (h-BN) is the most widely used polymorph and has been discovered to be particularly effective as a PPA for LLDPE compositions.

BN based PPA may be incorporated into LLDPE compositions as a powder. The particle size of the powder may range from 1 to 3 microns, or 4 to 6 microns, or 5 to 9 microns, or 15 to 20 microns, or 30 to 100 microns, or 100 to 150 microns. The purity of the BN is preferably greater than 99% with less than 1% oxygen, and more advantageously less than 0.5% oxygen. The bulk density of the BN powder may be 0.2 to 0.6, or 0.3 to 0.5.

The BN based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the BN based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, and various copolymers and terpolymers of ethylene, propylene and butylene.

Commercially available examples of suitable BN based PPAs include AdValue Technology Grades BN-AA, BN-A, BN-AS, BN-B, BN-SA, and BN-SC.

### 8. Polyamide Based PPAs

Polyamide based PPAs have also been discovered as a class of compounds that function effectively as PPAs in LLDPE compositions. In particular, aliphatic polyamides such as polyamide 6 (also called nylon 6) and polyamide 12 (also called nylon 12), are advantageous as PPAs.

The polyamide based PPAs disclosed herein may be incorporated into the LLDPE compositions (e.g. resin or film) at loadings of from 100 to 10,000 ppm, or 200 to 8000 ppm, or 300 to 5000 ppm, or 500 to 2000 ppm, or 800 to 1500 ppm. Alternatively, the polyamide based PPAs disclosed herein may be incorporated into the LLDPE compositions as a polyolefin masterbatch at loadings from of at least 1 wt. %, or at least 5 wt. %, or at least 10 wt. %, or at least 15 wt. %, or at least 20 wt. %, or at least 30 wt. %, or at least 40 wt. %, or at least 50 wt. %. Non-limiting exemplary carrier resins for the polyolefin masterbatches include LLDPE, LDPE, MDPE, HDPE, PP, PB-1, and various copolymers and terpolymers of ethylene, propylene and butylene.

### Methods of Blending Inventive PPAs Into LLDPE Compositions

Methods of introducing or blending the inventive PPAs into LLDPE compositions of the instant disclosure include adding the inventive PPA neat or, equivalently, a masterbatch of the inventive PPA to LLDPE composition (e.g., polymer granules and/or slurry) exiting a polymerization reactor to form a pre-finished polymer mixture in or upstream of a compounding extruder. The pre-finished polymer mixture therefore includes the LLDPE polymer and inventive PPA composition (both per above respective descriptions), as well as any optional other additives (which may be provided to the mixture along with, before, or after the inventive PPA). The pre-finished LLDPE polymer mixture may, for example, be a polymer melt (e.g., formed in or just upstream of a compounding extruder). The LLDPE mixture is then extruded and optionally pelletized to form a further LLDPE polymer composition (e.g., LLDPE polymer pellets) comprising the above described inventive PPA and LLDPE polymer (each per above, and with the inventive PPA in amounts in accordance with the above discussion), as well as any optional other additive(s) described below.

Also or instead, methods may include mixing finished LLDPE polymer (e.g., LLDPE pellets) with an inventive PPA (either neat or as a masterbatch) to form a LLDPE mixture; and processing the LLDPE mixture to form a LLDPE blown film or a LLDPE cast film. Such processing may be in accordance with well-known methods in the art, and in particular in accordance with blown film and cast film extrusion.

Hence, more generally, methods of the present disclosure can include: blending an inventive PPA described above (neat or as a polyolefin masterbatch) with a LLDPE composition to form a LLDPE mixture, and forming the LLDPE mixture into a LLDPE product. The blending can be carried out as part of a finishing process (e.g., wherein the LLDPE composition is a reactor-grade LLDPE polymer such as granules; and the LLDPE product comprises polymer pellets, and then providing a ready-to-use LLDPE resin product for making films or other polymeric articles). Or, the blending of the inventive PPA can be carried out as part of a process for forming LLDPE articles such as films-for example, wherein the LLDPE composition is a finished polymer composition such as LLDPE resin or pellets; and the LLDPE product comprises a LLDPE article such as a film. Such processes highlight a flexible approach, wherein LLDPE pellets or other finished LLDPE product without PPA are made ready for blown film or other article production through addition of the inventive PPA compositions described above (e.g., neat or masterbatch).

The inventive PPAs described above are particularly advantageous in eliminating melt fracture in blown LLDPE films. When the inventive PPAs disclosed herein are used to produce LLDPE blown films, the films will exhibit similar or superior properties compared to LLDPE films comprising conventional fluoropolymer based PPAs. This also exemplifies embodiments of the present disclosure including inventive PPA masterbatches, which could make for flexible LLDPE products ready for addition to any number of finished LLDPE products as needed for article production, such as blown film or cast film.

### Other Additives

Other additives optionally may be present in the LLDPE compositions including the inventive PPAs disclosed herein. These other additives may include antioxidants, stabilizers such as UV stabilizers, catalyst neutralizers, as well as, slip agents, antiblock agents, heat seal enhancing additives, clarifying agents, and other additives known in the art of polymerization, compounding and film or pipe extrusion.

Additive packages including a combination of one or more additives in a carrier resin may also be used. For example, an additive package including antiblock and/or slip agents, potentially along with other additives. Non-limiting exemplary antiblock agents for the LLDPE compositions disclosed herein include talc, crystalline and amorphous silica, nepheline syenite, diatomaceous earth, clay, or combinations thereof. Non-limiting exemplary slip agents for the LLDPE compositions disclosed herein include amides such as erucamide and other primary fatty amides like oleamide; and further include certain types of secondary (bis) fatty amides.

Antiblock agent loadings in the LLDPE compositions disclosed herein may be from 500 to 6000 ppm, or 1000 to 5000 ppm. Slip agent loadings in the LLDPE compositions disclosed herein may be 200 to 1000 ppm, or 400 to 2000 ppm, or 600 to 3000 ppm. Other additives may also be included in the LLDPE compositions disclosed herein, for example the following: fillers; antioxidants (e.g., hindered phenolics such as IRGANOX™ additives available from Ciba-Geigy); tackifiers, such as terpene resins, aliphatic and aromatic hydrocarbon resins, alkali metal and glycerol stearates, and hydrogenated rosins; UV stabilizers; heat stabilizers; release agents; anti-static agents; pigments; colorants; dyes; waxes; silica; fillers; talc; and combinations thereof. Where such other additives are utilized in the LLDPE compositions disclosed herein, they are also preferably free or substantially free of fluorine.

### EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Test Methods

Melt fracture % was measured by eye and is the fraction (based on % area) of melt fracture that was estimated visually from a 1 foot wide sample of blown film in the transverse direction, taken as a percentage of the area with noticeable, characteristic melt fracture streaks or roughness in the machine direction.

Melt index (MI), high load melt index (HLMI) was measured per ASTM D-1238, 2.16 kg (melt index) or 21.6 kg (high load melt index) at 190 deg. C.

Melt index ratio is HLMI divided by MI.

Density was measured per ASTM D1505.

### Melt Fracture Evaluation Trials With Different PPAs

Blown film trials were conducted on a blown film extrusion line with extruder and die characteristics, process conditions, and temperature profile as indicated below.

Die diameter (in.): 2.5; Die gap (mil): 75; Chimney height (in): 2; Film gauge (mil): 1; Blow up Ratio: 2.5; Frostline height (in): 7; Output (lbs/hr): 20; Line speed (fpm): 14.5; Extruder zone temps (deg. F.): 375/375/375/375; Screen changer temp. (deg. F.) 375; Die zone temps (deg. F.): 375; and Target melt temp. (deg. F.): 390.

The LLDPE resin used as the base resin for the blown film trials with the various inventive PPAs and the comparative (control) PPA was LyondellBasell, which has a density=0.918 and a MI=1.0.

The same general process was used for blown film production for each trial run for investigating the elimination of melt fracture using different inventive PPAs and the control PPA using the above LLDPE resin. For each evaluation, a test timer was set to 0 and a feed test resin (LLDPE plus particular PPA for testing) was extruded at the target output rate at the process conditions indicated above. Every 10 minutes, a film sample was collected and labeled with the test PPA, date and collection time for visual inspection to determine the % of melt fracture remaining in the film at the given 10-minute interval by measuring the width of the melt fracture region in millimeters. The greater the width of the melt fracture region in millimeters (305 mm equivalent to 100% melt fracture) of the film sample, the greater the melt fracture % in the sample at a given point in time. Each test run was continued for a time period of 90 minutes. As the PPA-containing resin of each trial was fed, the melt fractures slowly began to disappear in streaks. More particularly, as the PPA was added, melt fracture-free regimes began to emerge as stripes in the machine direction of the blown film. Over time, the stripes grew in width and the melt fracture zones diminished in width, and were sometimes eventually eliminated within the 90 minute test time. Between test runs with different PPAs, the blown film extrusion system was purged.

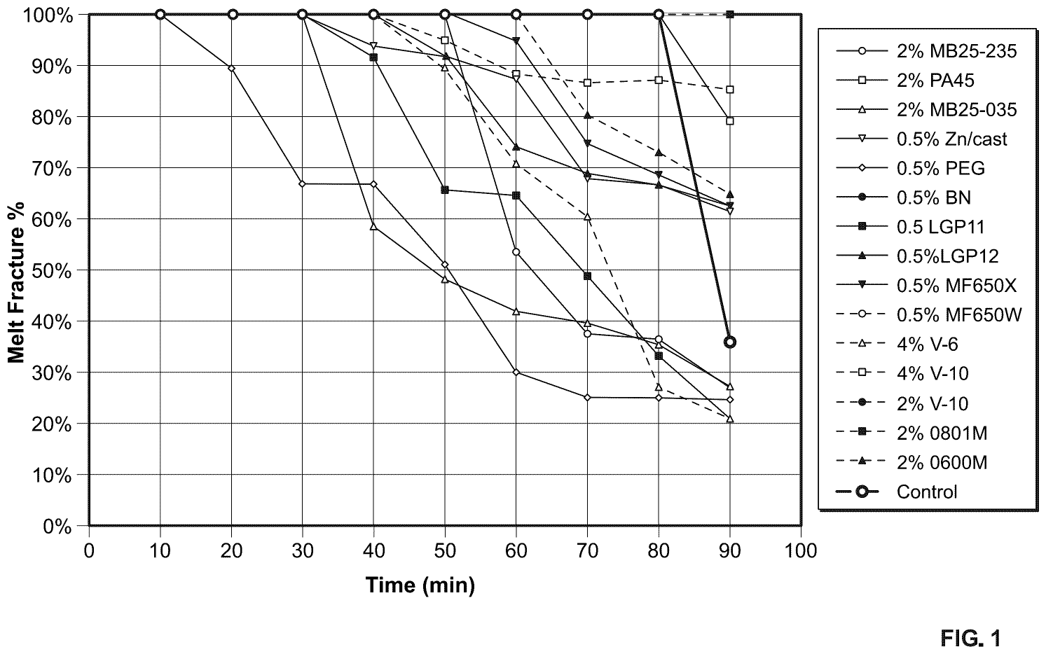

The results of the trials with different inventive PPAs and the comparative (control) PPA are summarized in FIGS. 1 to 11 herein.

The inventive PPAs of the instant disclosure described above fall into the following 8classes: 1. Polyethylene Glycol (PEG) PPAs, 2. Metal Salts of Fatty Acids Based PPAs, 3. Silicone Based (polysiloxane) PPAs, 4. High Melt Flow Rate Polypropylene Based PPAs, 5. High Melt Flow Rate Polybutene-1 Based PPAs, 6. Polyphosphite Based PPAs, 7. Boron Nitride Based PPAs, and 8. Polyamide Based PPAs. The comparative (control) PPA of the instant disclosure for comparison to the inventive PPAs was a fluoropolymer based PPA described below. Commercially available samples of the inventive PPAs and the comparative PPA were either blended neat into the LLDPE blown film or blended as a masterbatch into the LLDPE blown film in order to assess melt fracture performance using the blown film evaluation method described above.

The details for the legends of the melt fracture as a function of time tabular data and graphical data depicted herein in FIGS. 1-11 for the various inventive examples and comparative example are as follows:
1. “Process Aid Control” is 1300 ppm of 3M Dynamar Polymer Processing Aid FX5920A (fluoropolymer processing aid) in an LLDPE (1.0 MI, 0.918 g/cc density) from LyondellBasell. Comparative Fluoropolymer Based Example.
2. “2% MB25-235” is 2 wt. % of Dupont Multibase MB25-235 Masterbatch (siloxane polymer in LDPE carrier resin) in LLDE. Inventive Silicone based PPA Example.
3. “2% PA-45” is 2 wt. % of Dynamix Everglide PA45 (functional siloxane in PE carrier resin) in LLDPE. Inventive Silicone based PPA Example.
4. “2% MB25-035” is 2 wt. % of Dupont Multibase MB25-035 Masterbatch (siloxane polymer in LDPE carrier resin) in LLDE. Inventive Silicone based PPA Example.
5. “0.5% Zn/CaSt” is 0.5 wt. % of zinc stearate and calcium stearate in LLDPE. Inventive Metal salt of Fatty Acid based PPA.
6. “0.5% PEG (Carbowax 400)” is 0.5 wt. % of Dow Carbowax™ PEG 400 in LLDPE. Inventive Silicone based PPA.
7. “0.5% BN (Boron Nitride)” is 0.5 wt. % of Boron Nitride in LLDPE. Inventive BN based PPA.
8. “0.5 LGP11 (Phosphite)” is 0.5 wt. % of Dover LGP-11 polymer phosphitc stabilizer in LLDPE. Inventive Polyphosphite based PPA.
9. “0.5 LGP12 (Phosphite)” is 0.5 wt. % of Dover LGP-12 polymer phosphite stabilizer in LLDPE. Inventive Polyphosphite based PPA.
10. “0.5% MF650X (High MFR PP)” is 0.5 wt. % Metocene MF650X (PP homopolymer of 1200 MFR) in LLDPE. Inventive high MFR PP based PPA.
11. “0.5% MF650W (High MFR PP)” is 0.5 wt. % Metocene MF650W (PP homopolymer of 500 MFR) in LLDPE. Inventive high MFR PP based PPA.
12. “4% V-6 (PEG MB)” is 4 wt. % of Clariant Polyglykol 8000S PEG masterbatch in LLDPE. Inventive PEG based PPA.
13. “4% V-10 (Phosphite MB)” is 4 wt. % of Songnox PQ polyphosphate masterbatch in LLDPE. Inventive Polyphosphite based PPA.
14. “2% V-10 (Phosphite MB)” is 2 wt. % of Songnox PQ polyphosphate masterbatch in LLDPE. Inventive Polyphosphite based PPA.
15. “2% 0801M (Polybutene)” is 2 wt. % of Koattro PB 0801M (homopolymer PB-1 of 200 MFR). Inventive high MFR PB-1 based PPA.
16. “2% 0600M (Polybutene)” is 2 wt. % of Koattro PB M 0600M (homopolymer PB-1 of 600 MFR). Inventive high MFR PB-1 based PPA.
17. “1% AMF 7005” is blend of 1% of multifunctional polyester modified siloxane in LLDPE. Inventive Silicone based PPA.

### EXAMPLE 1

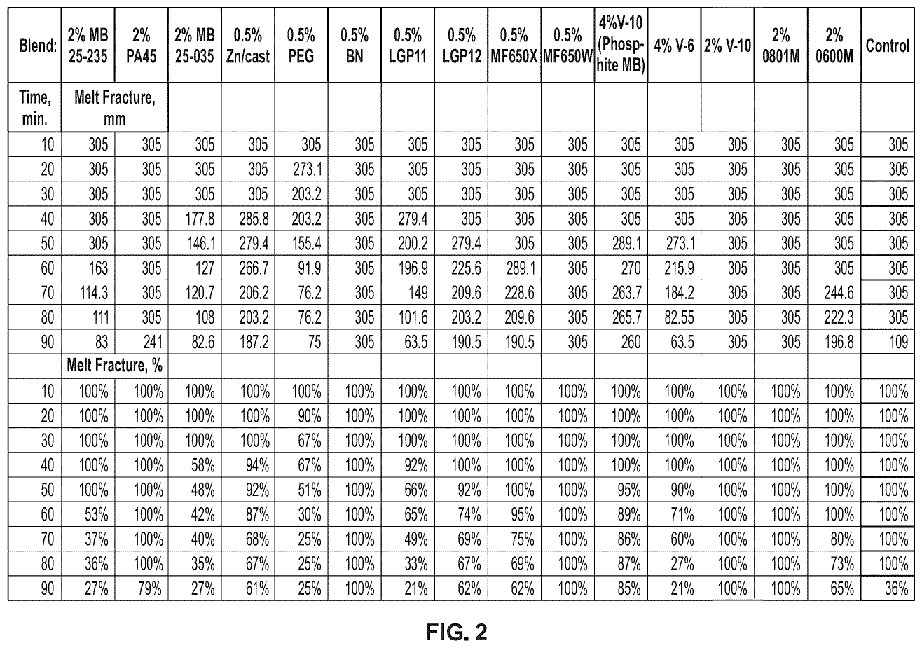

The results from the Example 1 trials are summarized below in FIGS. 1 and 2. Example 1 represents a comparison of almost all of the inventive PPAs tested, and also relative to the fluorine containing control PPA in blown LLDPE film. FIG. 1 is a graphical depiction and FIG. 2 is a tabular representation of the observed melt fracture % over time for the blown PE films formed from the total of 18 blown film trials used to test the 16 different (15 inventive PPA, 1 comparative PPA). As can be seen in FIG. 1, all of the inventive PPAs tested, with the exception of 2% PA45 (functionalized siloxane), 0.5% MF650W (High MFR PP), 2% V-10 (Phosphite MB), 2% 0801M (Polybutene) and 0.5% BN, provided improved performance in terms of a decreased time at which melt fracture started to dissipate relative to the fluoropolymer containing control (Process Aid Control) sample.

It should be noted however that for high MFR PP PPAs, that the 0.5% MF650X (1200MFR PP) provided much improved melt fracture performance relative to the 0.5% MF650W (500MFR PP). Hence, the test data indicates that a high MFR PP PPA with a MFR greater than 500 g/10 min. is advantageous on melt fracture dissipation in LLDPE films. It should also be noted however that for high MFR PB-1 PPAs, that the 2% 0600M (600 MFR PB-1) provided much improved melt fracture performance relative to the 2% 0801M (200 MFR PB-1). Hence, the test data indicates that a high MFR PB-1 PPA with a MFR greater than 200 g/10 min. is advantageous on melt fracture dissipation in LLDPE films. It is also notable from FIGS. 1 and 2 that for inventive Polyphosphite PPAs, that the 4% V-10 (Phosphite MB) provided much improved melt fracture performance relative to the 2% V-10 (Phosphite MB). Hence, the test data indicates that for a Polyphosphite PPA, a loading of greater than 2% of the Polyphosphite masterbatch is advantageous on melt fracture dissipation in LLDPE films.

### EXAMPLE 2

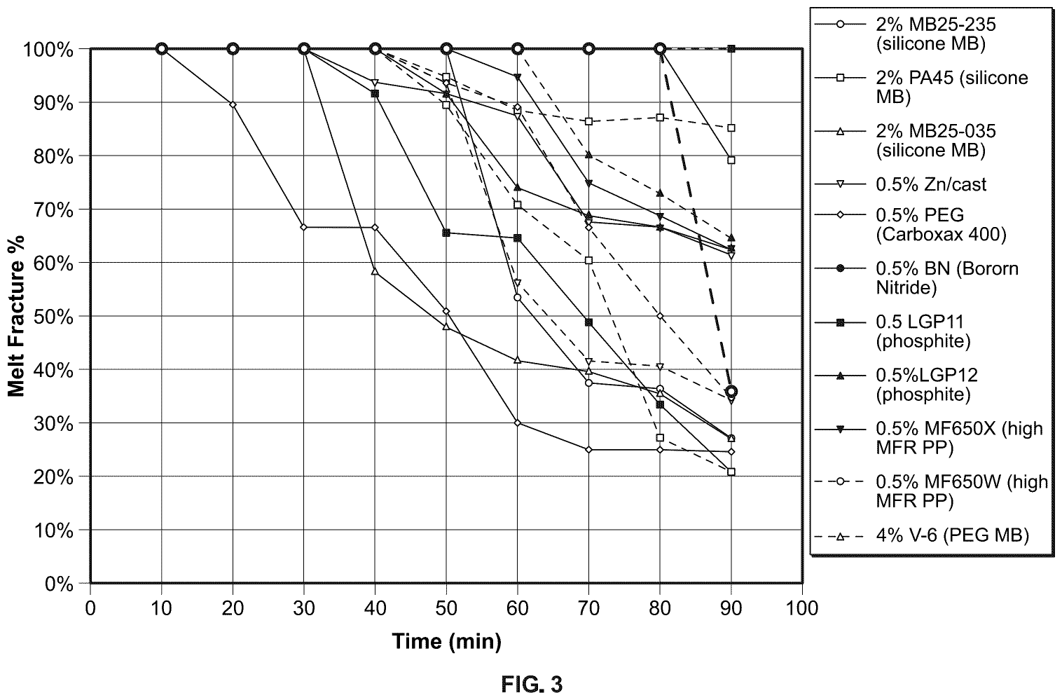

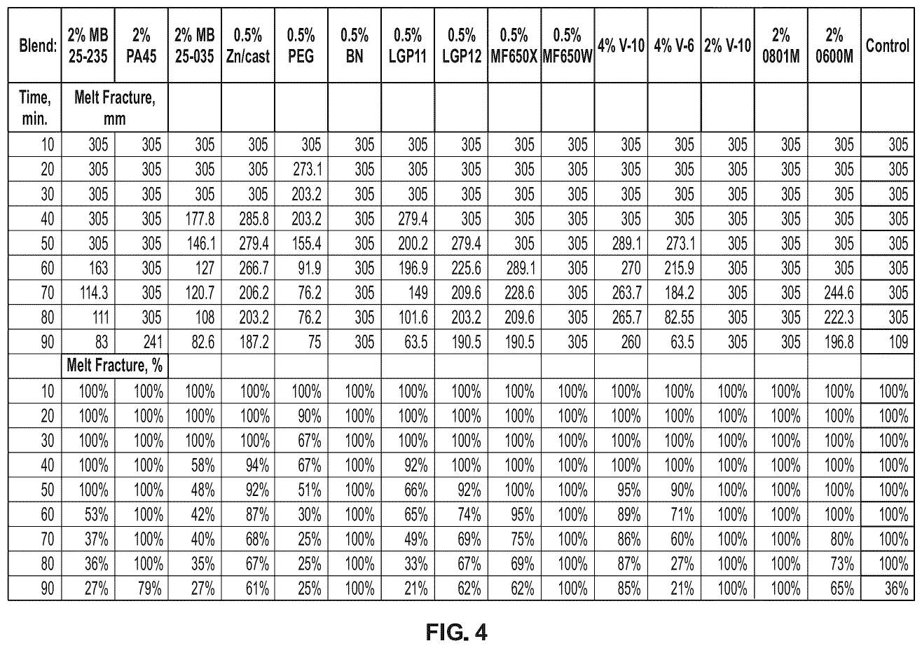

Example 2 herein represents a depiction of 11 of the inventive PPAs of Example 1along with the 1 comparative PPA. The results are summarized herein in FIGS. 3 and 4. FIG. 3 is a graphical depiction and FIG. 4 is a tabular representation of the observed melt fracture % over time for the blown PE films formed from the total of 11 blown film trials used to test the 11 different (10 inventive PPA, 1 comparative PPA). As can be seen in FIG. 3, all of the inventive PPAs tested, with the exception of 2% PA45 (functionalized siloxane), 0.5% MF650W (High MFR PP), and 0.5% BN provided improved performance in terms of a decreased time at which melt fracture started to dissipate relative to the fluoropolymer containing control (Process Aid Control) sample.

### EXAMPLE 3

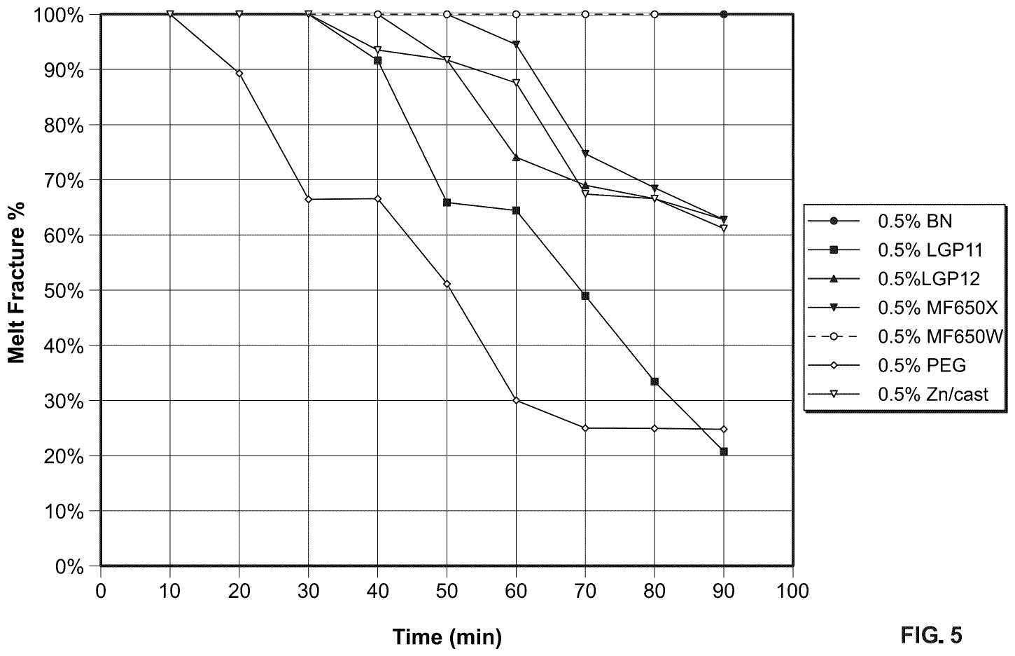

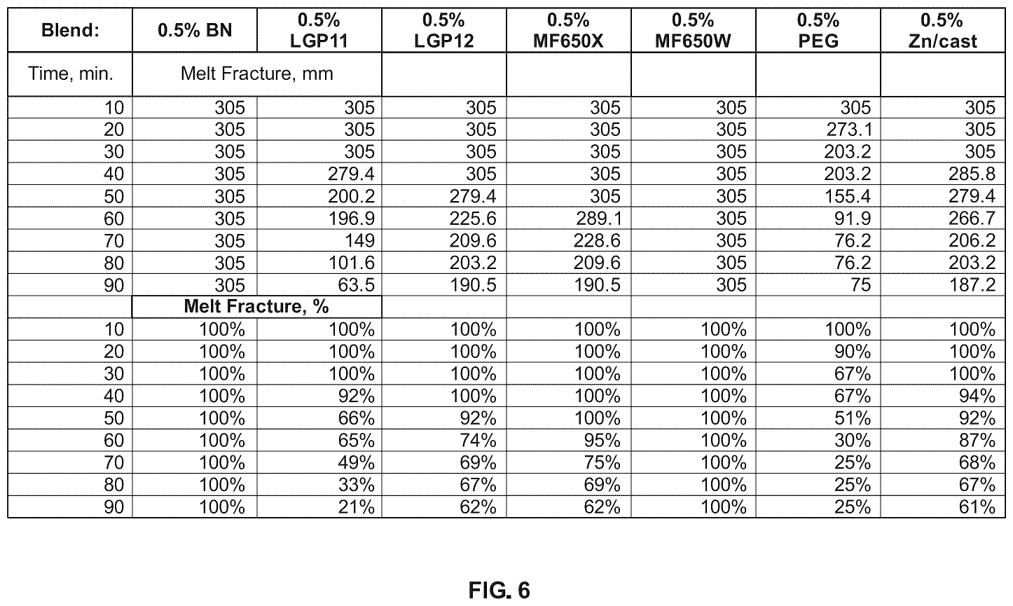

Example 3 herein represents a depiction of 7 of the inventive PPAs of Example 1. For all the LLDPE film samples of Example 3, the inventive PPAs were directly compounded or blended into the LLDPE film during LLDPE blown film processing (as opposed to being introduced as a masterbatch). The results are summarized herein in FIGS. 5 and 6. FIG. 5 is a graphical depiction and FIG. 6 is a tabular representation of the observed melt fracture % over time for the blown PE films formed from the total of 7 blown film trials used to test the 7 different inventive PPAs. As can be seen in FIG. 5, all of the directly compounded inventive PPAs, with the exception of 0.5% MF650W (600 MFR PP), and 0.5% BN provided improved melt fracture performance to the LLDPE blown film within 90 minutes.

### EXAMPLE 4

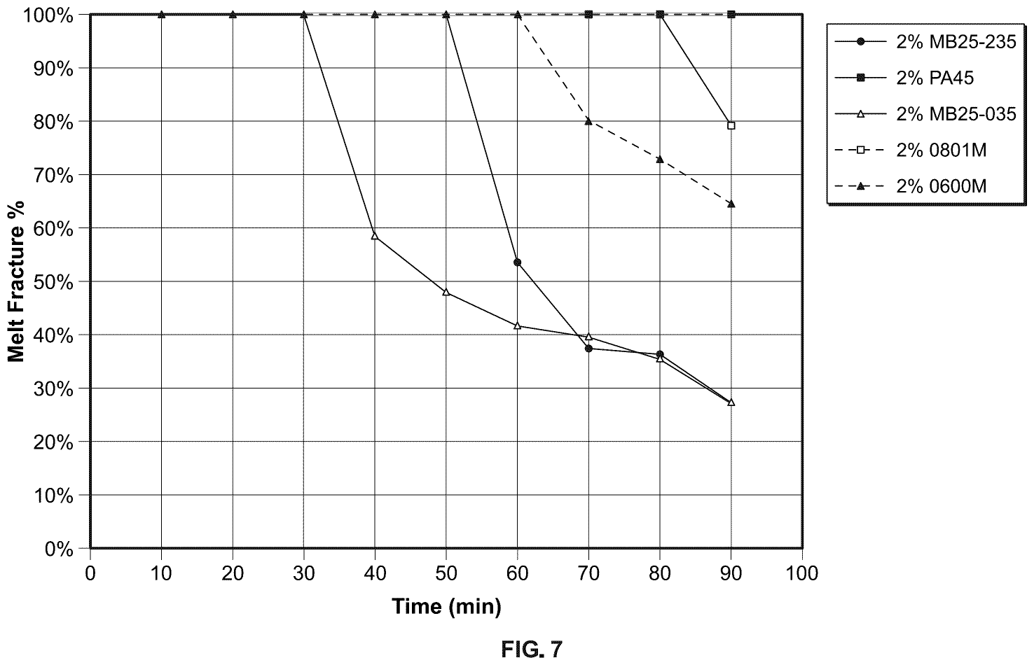

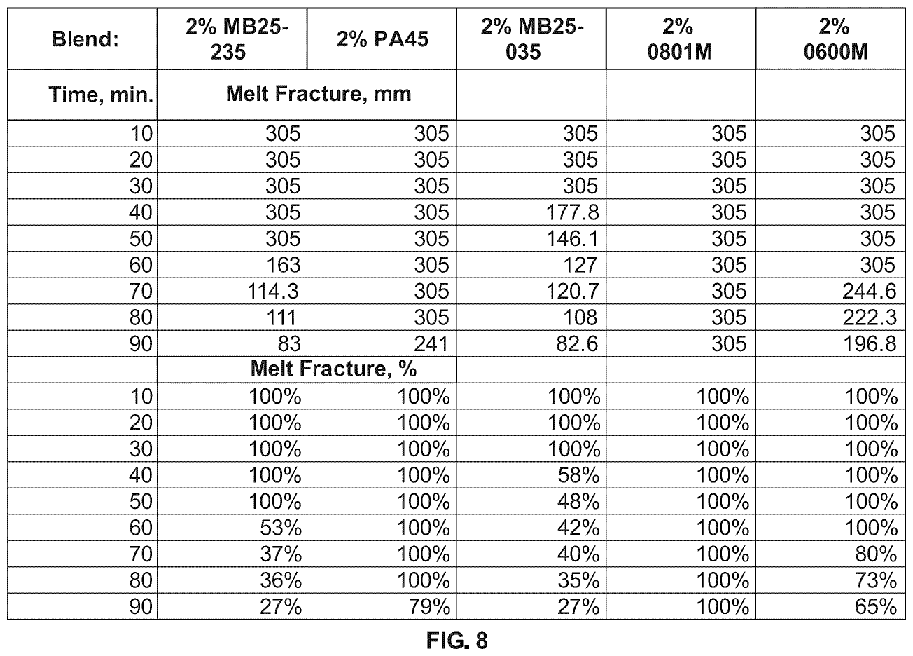

Example 4 herein represents a depiction of 5 of the inventive PPAs of Example 1. For all the LLDPE film samples of Example 4, the inventive PPAs were blended into the LLDPE resin as a masterbatch (with the exception of 0801M and 0600M, which were direct blended at 2 wt. %) during the LLDPE blown film processing. The results are summarized herein in FIGS. 7 and 8. FIG. 7 is a graphical depiction and FIG. 8 is a tabular representation of the observed melt fracture % over time for the blown PE films formed from the total of 5 blown film trials used to test the 5 different inventive PPAs. As can be seen in FIG. 7, all of the masterbatch blended inventive PPAs, with the exception of 2% 0801M (500 MFR PB-1) provided improved melt fracture performance to the LLDPE blown film within 90 minutes.

### EXAMPLE 5

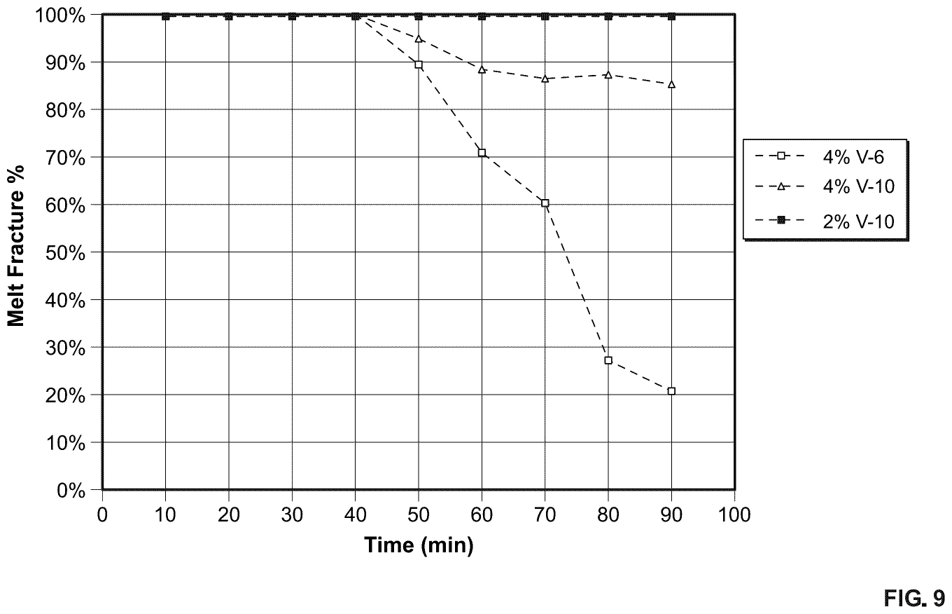

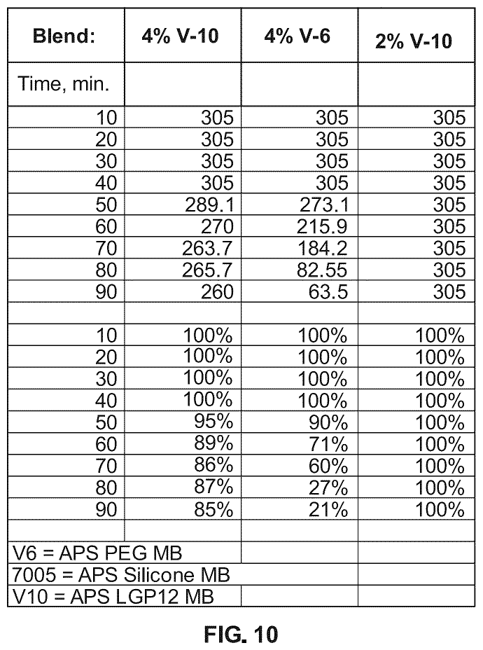

Example 5 herein represents a depiction of 5 other inventive PPAs of Example 1. For all the LLDPE film samples of Example 5, the inventive PPAs were masterbatches available from LyondellBasell Advanced Polymer Solutions (APS) and were blended into the LLDPE resin during LLDPE blown film processing. The results are summarized herein in FIGS. 9 and 10. FIG. 9 is a graphical depiction and FIG. 10 is a tabular representation of the observed melt fracture % over time for the blown PE films formed from the total of 4 blown film trials used to test the 4 different inventive PPAs. As can be seen in FIG. 9, all of the inventive PPAs tested, with the exception of 2% V-10 (Phosphite MB), provided improved melt fracture performance to the LLDPE blown film within 90 minutes.

As previously discussed with regard to FIGS. 1 and 2 above, for the inventive Polyphosphite PPAs, 4% V-10 (Phosphite MB) provided much improved melt fracture performance relative to the 2% V-10 (Phosphite MB). Hence, the test data indicates that for a Polyphosphite PPA, a loading of greater than 2% of the Polyphosphite masterbatch is advantageous on melt fracture dissipation in LLDPE films.

### EXAMPLE 6

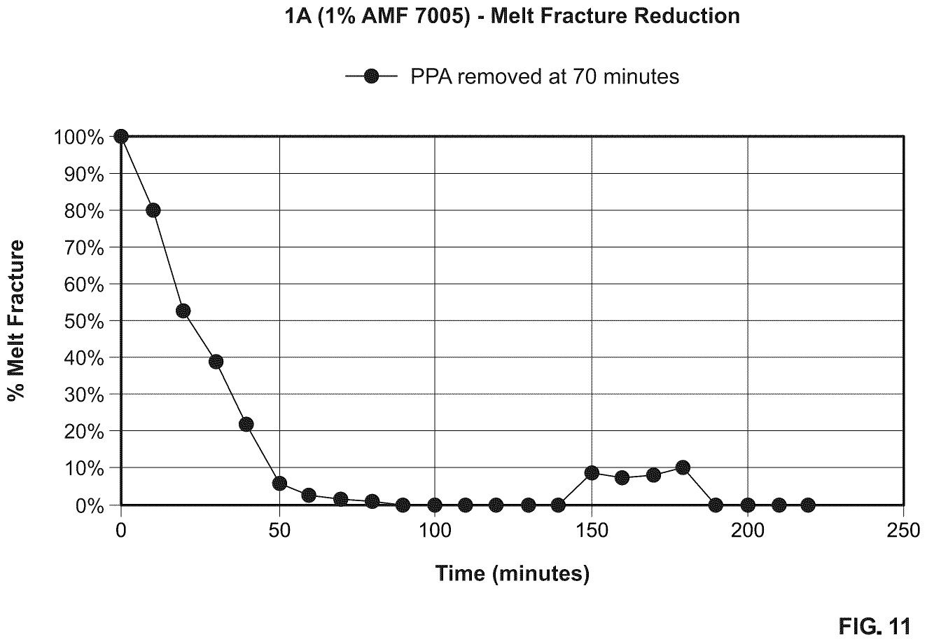

In this example, melt fracture performance of 1% of multifunctional polyester modified siloxane in LLDPE blown film was evaluated using the methods described above. The results from the Example 6 trial are summarized in FIG. 11, which is a graphical depiction of the observed melt fracture % over time for the blown LLDPE films formed from 1% of multifunctional polyester modified siloxane masterbatch in LLDPE. As can be seen in FIG. 11, at a time of between 60 and 70 minutes, melt fracture was completely eliminated and the 1% of multifunctional polyester modified siloxane masterbatch was then removed from the LLDPE film. Hence, it is concluded that 1% of multifunctional polyester modified siloxane masterbatch (multifunctional polyester modified siloxane) in LLDPE blown film is particularly effective in completely eliminating melt fracture before 70 minutes of its introduction into the LLDPE blown film extrusion melt system.

### Other Embodiments

A1. A linear low density polyethylene (LLDPE) composition comprising a LLDPE polymer and from 100 ppm to 10,000 ppm of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.
A2. The LLDPE composition of paragraph A1, wherein the LLDPE polymer is a metallocene-catalyzed LLDPE, a Ziegler Natta-catalyzed LLDPE, or combinations thereof.
A3. The LLDPE composition of paragraph A1 or A2, wherein the composition is in the form of resin pellets, an article, a blown film or a cast film.
A4. The LLDPE composition of paragraph A3, wherein the blown film or cast film is such that at 90 minutes of forming the blown film or cast film, % melt fracture (on basis of area of the film's surface) is less than equal to 35%.
A5. The LLDPE composition of paragraph A1 (or A2-A4), wherein the high MFR polypropylene and the high MFR polybutene-1 have a melt flow rate greater than 500 g/10 min. as measured by ISO 1133-1.
A6. The LLDPE composition of paragraph A1 (or A2-A5), wherein the metal salt of a fatty acid is calcium stearate, zinc stearate or a combination thereof.
A7. The LLDPE composition of paragraph A1 (or A2-A6), wherein the polymer processing aid is from 500 to 5000 ppm of the composition.
A8. The LLDPE composition of paragraph A1 (or A2-A8) further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.
B1. A polyolefin masterbatch comprising a polyolefin polymer and from 1 wt. % to 50 wt. % of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.
B2. The polyolefin masterbatch of paragraph B1, wherein the polyolefin polymer is selected from the group consisting of LLDPE; LDPE; MDPE; HDPE; PP; PB-1; copolymers and terpolymers of ethylene, propylene and butylene; and combinations thereof.
B3. The polyolefin masterbatch of paragraph B1 or B2, wherein the high MFR polypropylene and the high MFR polybutene-1 have a melt flow rate greater than 500 g/10 min. as measured by ISO 1133-1.
B4. The polyolefin masterbatch of paragraph B1 (or B2-B3), wherein the metal salt of a fatty acid is calcium stearate, zinc stearate or a combination thereof.
B5. The polyolefin masterbatch of paragraph B1 (or B2-B4) further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.
B6. The polyolefin masterbatch of paragraph B1 (or B2-B5), wherein the masterbatch is blended into a LLDPE blown film or cast film extrusion process to provide a loading of 100 ppm to 10,000 ppm of the polymer processing aid in the blown film or cast film, and such that at 90 minutes of forming the blown film or cast film, % melt fracture (on basis of area of the film's surface) is less than equal to 35%.
B7. The polyolefin masterbatch of paragraph B6, wherein the masterbatch is blended into a LLDPE blown film or cast film extrusion process to provide a loading of 500 ppm to 5000 ppm of the blown film or cast film.
B8. The polyolefin masterbatch of paragraph B6 or B7, wherein the LLDPE blown film or cast film is formed from a metallocene-catalyzed LLDPE, a Ziegler Natta-catalyzed LLDPE or combinations thereof.
C1. A method of decreasing melt fracture in linear low density polyethylene films comprising: extruding a linear low density polyethylene resin into a blown film or cast film on a film extrusion line; blending into the extrusion line from 100 ppm to 10,000 ppm of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride; and wherein the blown film or cast film is such that at 90 minutes of forming the blown film or cast film, % melt fracture (on basis of area of the film's surface) is less than equal to 35%.
C2. The method of paragraph C1, wherein the polymer processing aid is directly blended into the extrusion line or blended into the extrusion line as a masterbatch.
C3. The method of paragraph C1 or C2 wherein the LLDPE resin is a metallocene-catalyzed LLDPE, a Ziegler Natta-catalyzed LLDPE or combinations thereof.
C4. The method of paragraph C1 (or C2-C3), wherein the high MFR polypropylene and the high MFR polybutene-1 have a melt flow rate greater than 500 g/10 min. as measured by ISO 1133-1.
C5. The method of paragraph C1 (or C2-C4), wherein the metal salt of a fatty acid is calcium stearate, zinc stearate or a combination thereof.
C6. The method of paragraph C1 (or C2-C5), wherein the polymer processing aid is from 500 to 5000 ppm of the blown film or cast film.
C7. The method of paragraph C1 (or C2-C6) further including blending into the film extrusion line one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.
C8. The method of paragraph C2 (or C3-C7), wherein the masterbatch comprises a polyolefin polymer and from 1 wt. % to 50 wt. % of the polymer processing aid (PPA).

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of the ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A linear low density polyethylene (LLDPE) composition comprising a LLDPE polymer and from 100 ppm to 10,000 ppm of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.

2. The LLDPE composition of claim 1, wherein the LLDPE polymer is a metallocene-catalyzed LLDPE, a Ziegler Natta-catalyzed LLDPE, or combinations thereof.

3. The LLDPE composition of claim 1, wherein the composition is in the form of resin pellets, an article, a blown film or a cast film.

4. The LLDPE composition of claim 3, wherein the blown film or cast film is such that at 90 minutes of forming the blown film or cast film, % melt fracture (on basis of area of the film's surface) is less than equal to 35%.

5. The LLDPE composition of claim 1, wherein the high MFR polypropylene and the high MFR polybutene-1 have a melt flow rate greater than 500 g/10 min. as measured by ISO 1133-1.

6. The LLDPE composition of claim 1, wherein the metal salt of a fatty acid is calcium stearate, zinc stearate or a combination thereof.

7. The LLDPE composition of claim 1, wherein the polymer processing aid is from 500 to 5000 ppm of the composition.

8. The LLDPE composition of claim 1 further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.

9. A polyolefin masterbatch comprising a polyolefin polymer and from 1 wt. % to 50 wt. % of a polymer processing aid (PPA) that is substantially free of fluorine-containing compounds, wherein the polymer processing aid is a polyphosphite, a polysiloxane, a polyethylene glycol, a high MFR polypropylene, a high MFR polybutene-1, a metal salt of a fatty acid, a polyamide, or a boron nitride.

10. The polyolefin masterbatch of claim 9, wherein the polyolefin polymer is selected from the group consisting of LLDPE; LDPE; MDPE; HDPE; PP; PB-1; copolymers and terpolymers of ethylene, propylene and butylene; and combinations thereof.

11. The polyolefin masterbatch of claim 9, wherein the high MFR polypropylene and the high MFR polybutene-1 have a melt flow rate greater than 500 g/10 min. as measured by ISO 1133-1.

12. The polyolefin masterbatch of claim 9, wherein the metal salt of a fatty acid is calcium stearate, zinc stearate or a combination thereof.

13. The polyolefin masterbatch of claim 9 further including one or more additives selected from the group consisting of UV stabilizers, catalyst neutralizers, slip agents, antiblock agents, heat seal enhancing additives, fillers, antioxidants, tackifiers, aliphatic and aromatic hydrocarbon resins, alkali metal and glycerol stearates, hydrogenated rosins, heat stabilizers, release agents, anti-static agents, pigments, colorants, dyes, silica, talc, and waxes.

14. The polyolefin masterbatch of claim 9, wherein the masterbatch is blended into a LLDPE blown film or cast film extrusion process to provide a loading of 100 ppm to 10,000 ppm of the polymer processing aid in the blown film or cast film, and such that at 90 minutes of forming the blown film or cast film, % melt fracture (on basis of area of the film's surface) is less than equal to 35%.

15. A method of decreasing melt fracture in linear low density polyethylene films comprising:
extruding a linear low density polyethylene resin into a blown film or cast film on an extrusion line; and
blending into the extrusion line a polymer processing aid (PPA) that is substantially free of fluorine-containing compounds to provide from 100 ppm to 10,000 ppm of the polymer processing aid (PPA) in the blown film or the cast film, wherein the polymer processing aid is a polyphosphite, a polysiloxane, a polyethylene glycol, a high MFR polypropylene, a high MFR polybutene-1, a metal salt of a fatty acid, a polyamide, or a boron nitride; and
wherein the blown film or cast film is such that at 90 minutes of forming the blown film or cast film, % melt fracture (on basis of area of the film's surface) is less than equal to 35%.

16. The method of claim 15, wherein the polymer processing aid is directly blended into the extrusion line or blended into the extrusion line as a masterbatch.

17. The LLDPE composition of claim 1, wherein the composition is in the form of a pipe.

18. The LLDPE composition of claim 1, wherein the composition is in the form of a sheath for wire and cable applications.
